(19) United States
(12) Patent Application Publication
(10) Pub. No.: US 2021/0192853 A1
(43) Pub. Date: Jun. 24, 2021

(54) METHOD AND SYSTEM FOR WIRELESS TRANSMISSION OF AUDIO/VIDEO MEDIA CONTENT TO A DISPLAY DEVICE

(71) Applicants: Abdul Zalil, Las Vegas, NV (US); Zarak Afridi, Dublin, CA (US)

(72) Inventors: Abdul Zalil, Las Vegas, NV (US); Zarak Afridi, Dublin, CA (US)

(21) Appl. No.: 17/247,730

(22) Filed: Dec. 21, 2020

Related U.S. Application Data
(60) Provisional application No. 62/951,712, filed on Dec. 20, 2019.

(51) Int. Cl. G06T 19/00; G02B 27/01; H04N 21/41

(52) U.S. Cl. CPC G06T 19/006; G02B 2027/0178; H04N 21/4122; G02B 27/017

(57) ABSTRACT

A system of wireless transmission of audio/video media content to a display device, the system includes a wireless transmitter operative to receive audio and/or video; the wireless transmitter adapted to setup a private wireless network; a display device operative to receive the audio and/or video; and a processor in communication with the wireless transmitter and the display device, wherein the processor is operative to wirelessly transmit via the private wireless network the audio and/or video to the display device without use of an intervening hardware or computing device, wherein the display device is a virtual reality headset operative to perform digital magnification on the audio and/or video.

### CROSS-REFERENCE TO RELATED APPLICATION

This application claims the benefit of priority of U.S. provisional applications: No. 62/951,712 filed 20 Dec. 2019, the contents of which are herein incorporated by reference.

### BACKGROUND OF THE INVENTION

The present invention relates to audio and video player systems and, more particularly, a method and system for wireless transmission of audio/video media content to a display device.

Millions of people with eye disorders like macular degeneration, retinitis pigmentosa, glaucoma, etc. cannot see clearly, and struggle with viewing television screen, computer user interfaces, tablets or any such display devices.

Current solutions involve existing devices and systems utilizing a camera on the virtual reality (VR) headset to capture the video content on another display device and reproducing the captured content. However, capturing a video source using a camera and then reproducing back on the VR headset greatly reduces the quality and experience of viewing the video content.

As can be seen, there is a need for a method and system for wireless transmission of audio/video media content to a display device.

The present invention uses wireless transmission of the source video and audio content to the virtual reality headset via a dedicated, private wireless network, eliminating dependency on external infrastructure, and thus greatly reducing loss in quality. The dedicated, private wireless network for transmission is pre-paired with the transmitter.

In other words, the present invention comprises a wireless video transmitter paired with a virtual reality device. The wireless video transmitter broadcasts HD video input coming from various video sources like cable TV set top boxes, internet TV devices, computer screen, movie projector, etc. to the virtual reality headset in real time. The virtual reality headset is automatically connected to the transmitter, and contains user controls to magnify, augment and enhance the incoming video.

### SUMMARY OF THE INVENTION

In one aspect of the present invention, a system of wireless transmission of audio/video media content to a display device, the system including the following: a wireless transmitter operative to receive audio and/or video; the wireless transmitter configured to setup a private wireless network; a display device operative to receive the audio and/or video; and a processor in communication with the wireless transmitter and the display device, wherein the processor is operative to wirelessly transmit via the private wireless network the audio and/or video to the display device without use of an intervening hardware or computing device, wherein the wireless transmission by way of the processor is in real time or wherein the processor encodes the audio and/or video into a streaming protocol prior to the wireless transmission, wherein the display device is a virtual reality headset, and wherein the display device is operative to perform digital magnification on the audio and/or video.

In another aspect of the present invention, a method for a person with limited vision to watch video content, the method includes the following: providing the above-mentioned system; operatively associating the virtual reality headset and the person; and electrically connecting audio and/or video with the wireless transmitter.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention;

FIG. 2 is a schematic view of an exemplary embodiment of the present invention;

FIG. 3 is a schematic view of an exemplary embodiment of the present invention; and

FIG. 4 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

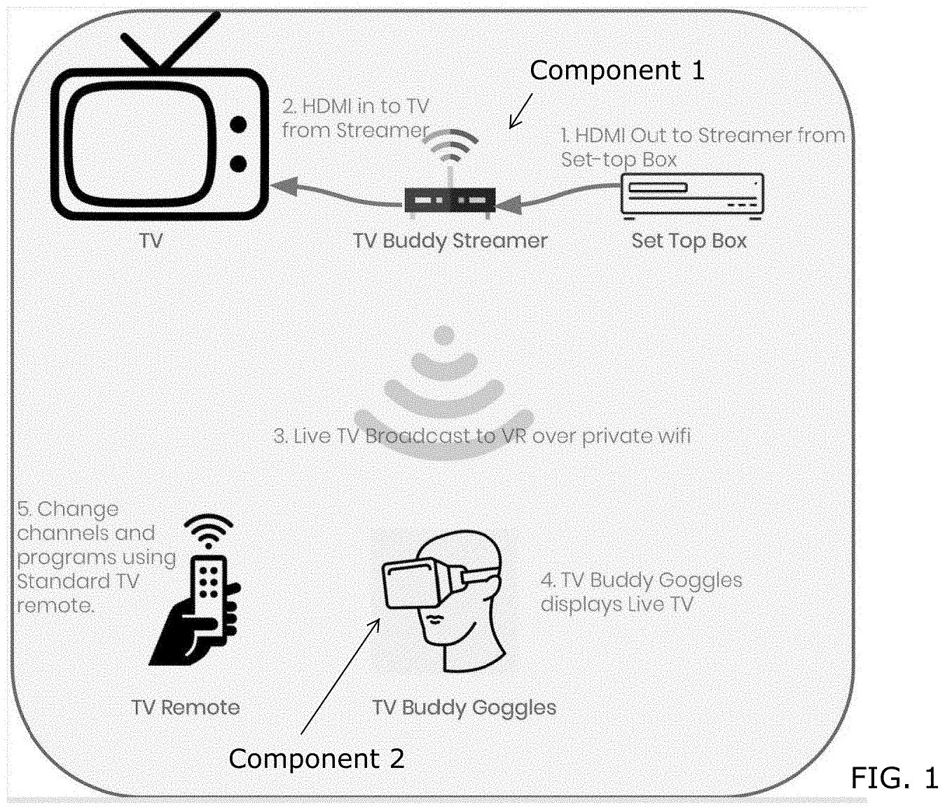

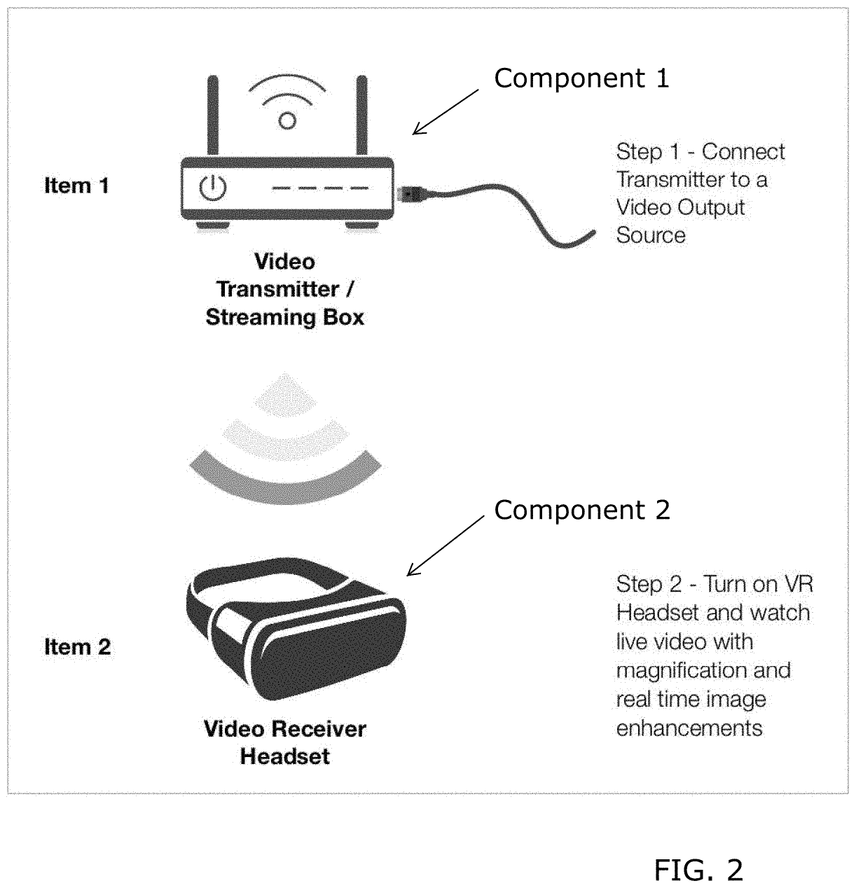

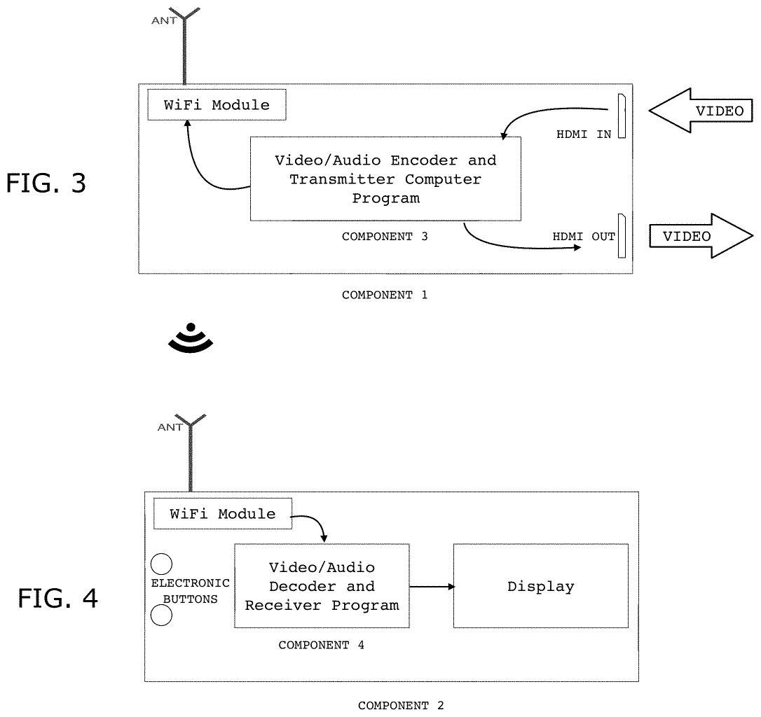

Referring now to FIGS. 1 through 4, the present invention may include a method and system for wireless transmission of audio/video media content to a display device. The systemic components include the following: Component 1, Wireless Encoder and Transmitter Equipment; Component 2, a Wireless Receiver and Display Device; Component 3, a Video/Audio Encoder and Transmitter Computer Program; and Component 4, a Video/Audio Receiver and Display Computer Program.

Component 1 is a hardware equipment comprising of (a) an HDMI IN port to receive audio/video signals, (b) a computer processing unit (CPU) to run Component 3 computer program, (c) a video encoder chipset, (d) wireless communication module to setup a dedicated, private wireless network, including related radio technologies and protocol standards (e) and an HDMI OUT port to retransmit wired to other display devices.

Component 1 is coupled with an external electronic device capable of producing HDMI signals. The electronic device is connected to Component 1 over HDMI IN Port. Examples of such electronic devices are cable tv set top box, apple tv, Chromecast™, computer screen, etc.

Component 3, a computer software program receives the audio/video signals in Component 1 through the HDMI IN Port and processes the audio/video signals using the Video Encoder Chipset. Component 3 encodes the signals into standard streaming protocols in H.264, H.265 or its own custom protocol. The encoded audio/video is made accessible over the private wireless network on Component 1 in real time.

Component 2 is a hardware equipment comprising of (a) a display device, (b) wireless module to connect to wireless network, (c) computer processing unit to run Component 4 computer program, (d) electronic buttons to operate certain feature of the computer program.

Component 4, a computer software program, runs on Component 2 and receives the audio/video content over streaming protocol, and performs various image enhancement and transformation operations in real time.

Component 4 can be controlled by the electronic buttons of Component 2 to operate the image enhancements and digital magnification.

Component 1 can also be coupled with another external electronic device over wired connection using HDMI OUT Port. Example of such external electronic device includes Television Display, LCD Monitor etc. Component 1 relays the incoming HDMI Signal on HDMI IN Port to the HDMI Port in real time.

In short, the method embodiment by the present invention includes the following:

Step 1: Component 1 receives the audio/video signal over its HDMI IN Port;

Step 2: Component 3 encodes the incoming video signal into a streaming protocol;

Step 3: Component 1 makes the encoded video signal accessible over its dedicated, private wireless network;

Step 4: Component 2 connects to component 1 over its dedicated, private wireless network;

Step 5: Component 4, running on Component 2 receives the audio/video content in streaming protocols and reproduces it back on digital display installed on Component 1;

Step 6: Component 4 enhances the incoming audio/video in real time using various image transformation protocols; and

Step 7: Component 2 controls certain aspects (like Zoom in/out) of video content using its electronic buttons.

The present invention enables the following:

a) Ability to capture audio/video signals from an external media source over physical connection (HDMI IN);

b) Ability to decode and encode audio/video signal;

c) Ability to wirelessly transmit encoded audio/video;

d) Ability to wirelessly receive encoded audio/video in real time from a transmitting source;

e) Ability to enhance encoded audio/video in real time;

f) Ability to control certain parameters of the image transformation and enhancement using peripheral electronic buttons; and

g) Ability to relay the incoming HDMI on HDMI IN port to HDMI Out port in real time.

### In Operation:

The present invention can be used to create a product to help people with low vision, or limited vision to watch the display of video content through connecting the wireless audio/video transmitter (Component 1) to their cable box or satellite box or any other video output source and interfacing with the VR headset (Component 2) and the image will stream directly into the headset (Using Component 3 and 4). The image quality will be enhanced in real time using Component 4, and also provide the option for further magnification of the image. In essence, the present invention is like watching TV on a cinema screen, allowing people with low vision or limited vision can view their laptops screens and read emails or another video source like skype, zoom, etc.

Additionally, the present invention can also be used to create a product for movie theaters to help low vision or legally blind people watch movies, or the present invention can also be used at education institutes for visually impaired students to view the presentation screens and smartboards. Alternatively, the present invention can be used by medical institutes to project live videos of organs or part of organs wirelessly to a display device for medical or informational purpose. For example, a dentist can use this invention to transmit live video of a patient's dental cavities to a virtual reality headset worn by the patient. The patient can see what the dentist sees and helps the dentist to explain dental conditions better to the patient.

Also, the present invention can create: As mentioned above, even though the initial application of the invention is performed in the area of Low Vision and Visual Impairment, the invention can be used in different forms to address problems in the area of:

In certain embodiments, the network may refer to any interconnecting system capable of transmitting audio, video, signals, data, messages, or any combination of the preceding. The network may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

The server and the computer of the present invention may each include computing systems. This disclosure contemplates any suitable number of computing systems. This disclosure contemplates the computing system taking any suitable physical form. As example and not by way of limitation, the computing system may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, a smart phone, an interactive kiosk, a mainframe, a mesh of computing systems, a server, an application server, or a combination of two or more of these. Where appropriate, the computing systems may include one or more computing systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example and not by way of limitation, one or more computing systems may perform in real time or in batch mode one or more steps of one or more methods described or illustrated herein. One or more computing systems may perform at different times or at different locations one or more steps of one or more methods described or illustrated herein, where appropriate.

In some embodiments, the computing systems may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing systems may be a web server running web server applications such as Apache, Microsoft's Internet Information Server™, and the like.

In particular embodiments, the computing systems includes a processor, a memory, a user interface and a communication interface. In particular embodiments, the processor includes hardware for executing instructions, such as those making up a computer program. The memory includes main memory for storing instructions such as computer program(s) for the processor to execute, or data for processor to operate on. The memory may include mass storage for data and instructions such as the computer program. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface includes hardware, software, or both providing one or more interfaces for communication between a person and the computer systems. As an example and not by way of limitation, an user interface device may include a keyboard, keypad, microphone, monitor, mouse, printer, scanner, speaker, still camera, stylus, tablet, touchscreen, trackball, video camera, another suitable user interface or a combination of two or more of these. A user interface may include one or more sensors. This disclosure contemplates any suitable user interface and any suitable user interfaces for them.

The communication interface includes hardware, software, or both providing one or more interfaces for communication (e.g., packet-based communication) between the computing systems over the network. As an example and not by way of limitation, the communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example and not by way of limitation, the computing systems may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing systems may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing systems may include any suitable communication interface for any of these networks, where appropriate.

It should be understood, of course, that the foregoing relates to exemplary embodiments of the invention and that modifications may be made without departing from the spirit and scope of the invention as set forth in the following claims.

What is claimed is:

1. A system of wireless transmission of audio/video content to a display device, the system comprising:
a wireless transmitter operative to receive audio and/or video;
the wireless transmitter configured to setup a private wireless network;
a display device operative to receive the audio and/or video; and
a processor in communication with the wireless transmitter and the display device, wherein the processor is operative to wirelessly transmit via the private wireless network the audio and/or video to the display device without use of an intervening hardware or computing device.

2. The system of claim 1, wherein the wireless transmission by way of the processor is in real time.

3. The system of claim 1, wherein the processor encodes the audio and/or video into a streaming protocol prior to the wireless transmission.

4. The system of claim 1, wherein the display device is a virtual reality headset.

5. The system of claim 4, wherein the display device is operative to perform digital magnification on the audio and/or video.

6. A method for a person with limited vision to watch video content, the method comprising:
providing the system of claim 5;
operatively associating the virtual reality headset and the person; and
electrically connecting audio and/or video with the wireless transmitter.
